(19) United States
(12) Patent Application Publication
(10) Pub. No.: US 2020/0252848 A1
(43) Pub. Date: Aug. 6, 2020

(54) IN-VEHICLE COMMUNICATION DEVICE, COMMUNICATION METHOD, AND SERVER DEVICE

(71) Applicant: TOYOTA JIDOSHA KABUSHIKI KAISHA, Toyota-shi (JP)

(72) Inventor: Kentaro ASAI, Okazaki-shi (JP)

(73) Assignee: TOYOTA JIDOSHA KABUSHIKI KAISHA, Toyota-shi (JP)

(21) Appl. No.: 16/714,872

(22) Filed: Dec. 16, 2019

(30) Foreign Application Priority Data
Feb. 5, 2019 (JP) 2019-018498

(51) Int. Cl. H04W 36/10; H04W 36/32; H04W 64/00; H04W 4/40; H04W 4/021; H04W 4/90; H04W 40/20; H04W 88/12; H04W 92/14

(52) U.S. Cl. CPC H04W 36/10; H04W 36/32; H04W 64/003; H04W 4/40; H04W 92/14; H04W 4/90; H04W 40/20; H04W 88/12; H04W 4/021

(57) ABSTRACT

In an in-vehicle communication device, a position acquisition unit acquires vehicle position information. A communication controller is communicable in any one of a first communication system and a second communication system. An area information holding unit holds area information indicating a communication area where communication in the first communication system is possible. A switching deciding unit decides switching between the first communication system and the second communication system based on the vehicle position information and the area information and decides the switching from the second communication system to the first communication system before a vehicle enters the communication area. The communication controller completes the switching to the first communication system before the vehicle enters the communication area in response to the deciding of the switching deciding unit.

### INCORPORATION BY REFERENCE

The disclosure of Japanese Patent Application No. 2019-018498 filed on Feb. 5, 2019 including the specification, drawings and abstract is incorporated herein by reference in its entirety.

### BACKGROUND

### 1. Technical Field

The disclosure relates to a technique that uses an in-vehicle communication device capable of wireless communication in different communication systems.

### 2. Description of Related Art

Japanese Unexamined Patent Application Publication No. 2015-119256 (JP 2015-119256 A) discloses a communication apparatus that avoids attempting to connect to a communication network through a communication line of a communication standard that cannot be used from a current position of the communication apparatus. This communication apparatus specifies an area where the communication apparatus is currently located and connects to the communication network using a communication line of a communication standard that can be used in the specified area with reference to a table in which a communication standard that can be used for each area is registered.

### SUMMARY

A process of switching communication lines of communication standards may take time. In the technique disclosed in JP 2015-119256 A, the communication apparatus enters an area where communication according to a predetermined communication standard is possible and then the communication apparatus is connected to a communication line of a communication standard corresponding to the area. Therefore, when the switching process of the communication lines takes time, there may be a case where the communication line cannot be fully used due to a movement of the communication apparatus from the area to another area.

The disclosure has been made in view of such circumstances and provides a technique that can fully use communication in a predetermined communication system when an in-vehicle communication device enters a communication area where the communication in the predetermined communication system is possible.

A first aspect of the disclosure relates to an in-vehicle communication device including: a position acquisition unit configured to acquire vehicle position information; and a communication controller configured to communicate in any one of a first communication system and a second communication system. The communication controller receives an instruction for switching derived based on a communication area where communication in the first communication system is possible and the vehicle position information and starts a switching process from the second communication system to the first communication system before a vehicle enters the communication area.

A second aspect of the disclosure relates to a communication method executed by an in-vehicle communication device communicable in any one of a first communication system and a second communication system. The method includes a step of acquiring vehicle position information; a step of holding area information indicating a communication area where communication in the first communication system is possible; a step of deciding switching from the second communication system to the first communication system before a vehicle enters the communication area based on the vehicle position information and the area information; and a step of starting a switching process from the second communication system to the first communication system before the vehicle enters the communication area in response to the deciding.

A third aspect of the disclosure relates to a server device that controls a switching process of a communication system in an in-vehicle communication device communicable in any one of a first communication system and a second communication system. The server device includes an area information holding unit configured to hold area information indicating a communication area where communication in the first communication system is possible; and a switching deciding unit configured to decides switching between the first communication system and the second communication system based on vehicle position information acquired from the in-vehicle communication device and the area information. The switching deciding unit decides the switching from the second communication system to the first communication system before a vehicle enters the communication area and transmits an instruction signal for starting the switching process to the in-vehicle communication device.

According to this disclosure, it is possible to provide the technique that can fully use communication in a predetermined communication system when an in-vehicle communication device enters a communication area where the communication in the predetermined communication system is possible.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram for describing an outline of an in-vehicle communication device;

FIG. 2 is a diagram showing a functional configuration of the in-vehicle communication device; and

FIG. 3 is a flowchart of a switching process of a communication system.

### DETAILED DESCRIPTION OF EMBODIMENTS

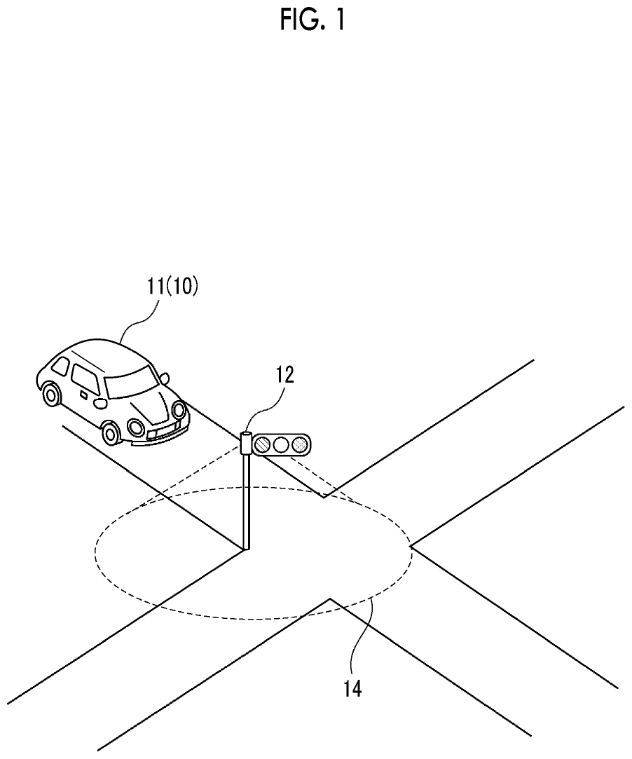

FIG. 1 is a diagram for describing an outline of an in-vehicle communication device 10. The in-vehicle communication device 10 is provided in a vehicle 11 and enables communication with an external server device or the like. The in-vehicle communication device 10 can communicate using communication systems of different communication standards and can use a fourth-generation mobile communication system (hereinafter referred to as “4G”) and a fifth-generation mobile communication system (hereinafter referred to as “5G”), respectively.

The in-vehicle communication device 10 cannot communicate simultaneously in the communication systems of 4G standard and 5G standard and performs a switching process of several tens of seconds at the maximum when the communication system is switched. The in-vehicle communication device 10 cannot communicate during the switching process. The communication according to the 5G standard has a higher communication speed than the communication according to the 4G standard.

A 5G communication environment has fewer installed antennas and a narrower communication area from the installed antennas than a 4G communication environment. FIG. 1 shows an installed antenna 12 for 5G communication provided at an intersection and a first communication area 14 where the communication with the installed antenna 12 is possible. The first communication area 14 is, for example, in a range of several tens of meters from the installed antenna 12. On the other hand, a second communication area for 4G communication substantially covers a road through which the vehicle 11 passes, and the first communication area 14 often partially overlaps the second communication area. The first communication area 14 is shown concentrically in FIG. 1. However, the area is not limited to this aspect and may have a shape along the road.

The in-vehicle communication device 10 communicates in the 4G communication system in many scenes and switches from the 4G communication system when there is the first communication area 14 to communicate in the 5G communication system. In this case, since the switching process takes several tens of seconds at the maximum, there may be a case where the vehicle 11 passes through the first communication area 14 before the communication in the 5G communication system is started.

The in-vehicle communication device 10 switches from the 4G communication system to the 5G communication system before the vehicle 11 enters the first communication area 14 to enable the communication in the 5G communication system when the vehicle 11 enters the first communication area 14. Accordingly, it is possible to efficiently use the communication in the 5G communication system and thus to transmit a video and the like collected on a drive recorder in a short time.

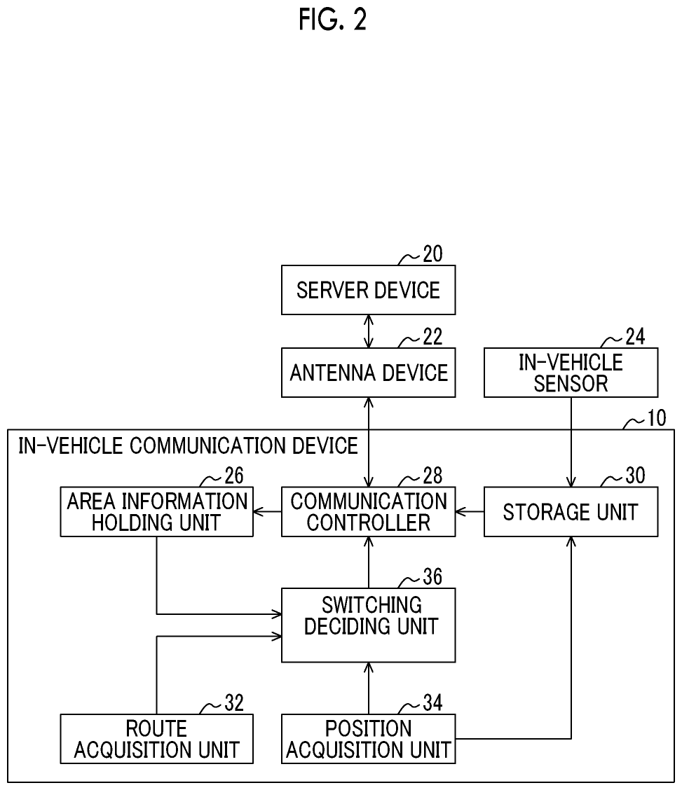

FIG. 2 shows a functional configuration of the in-vehicle communication device 10. In FIG. 2, each component described as functional blocks for performing various processes can be configured of a circuit block, a memory, and other LSIs in terms of hardware, and is realized by a program loaded into the memory in terms of software. Therefore, those skilled in the art understand that these functional blocks can be realized in various forms by hardware only, software only, or a combination thereof, and the disclosure is not limited to any one thereof.

The in-vehicle communication device 10 includes an area information holding unit 26, a communication controller 28, a storage unit 30, a route acquisition unit 32, a position acquisition unit 34, and a switching deciding unit 36, and is connected to an antenna device 22 and an in-vehicle sensor 24. The in-vehicle communication device 10 enables communication with an external server device 20 through the antenna device 22.

The server device 20 acquires vehicle information from the in-vehicle communication device 10 of each vehicle. The antenna device 22 includes an antenna element for 4G communication and an antenna element for 5G communication, respectively. In the antenna device 22, for example, connections of the antenna element for 4G communication and the antenna element for 5G communication to the communication controller 28 of the in-vehicle communication device 10 are switched by the control of the communication controller 28.

The in-vehicle sensor 24 includes a camera that images the surroundings of the vehicle, a microphone that detects sound inside or outside the vehicle, a sensor that detects a vehicle traveling state, and the like, and detects vehicle information. The detection result of the in-vehicle sensor 24 is transmitted to the storage unit 30.

The area information holding unit 26 of the in-vehicle communication device 10 holds area information indicating a position and range of the first communication area 14 where the communication in the 5G communication system is possible. The area information held by the area information holding unit 26 is periodically updated based on the information from the server device 20.

The route acquisition unit 32 acquires guidance route information set in an in-vehicle navigation function. The guidance route information is derived based on destination information set by an occupant and indicates a route for guiding the vehicle. The guidance route information is transmitted to the switching deciding unit 36.

The position acquisition unit 34 acquires position information of the vehicle using a global positioning system (GPS) and an acquisition timepoint when the position information thereof is acquired. The position information is transmitted to the switching deciding unit 36 and the storage unit 30.

The storage unit 30 stores the vehicle information acquired by the in-vehicle sensor 24 and the position acquisition unit 34, and functions as the drive recorder. A video or the like stored in the storage unit 30 is transmitted to the server device 20.

The switching deciding unit 36 decides the switching between the 4G communication system and the 5G communication system based on the position information of the vehicle and the area information. For example, the switching deciding unit 36 determines whether the vehicle approaches the first communication area 14 based on the position information of the vehicle and determines whether there is the first communication area 14 on the traveling road.

When the vehicle approaches the first communication area 14 and there is the first communication area 14 on the traveling road, the switching deciding unit 36 decides to switch from the 4G communication system to the 5G communication system before the vehicle enters the first communication area 14. The switching deciding unit 36 transmits an instruction to the communication controller 28 based on the deciding result to cause the communication controller 28 to start the switching process to the 5G communication system.

The switching deciding unit 36 acquires a predicted arrival timepoint when the vehicle arrives at the first communication area 14 and causes the communication controller 28 to start the switching process a predetermined time before the predicted arrival timepoint, for example, 30 seconds before the predicted arrival timepoint. The predicted arrival timepoint may be calculated from a distance of a route from the vehicle to the first communication area 14 and an average vehicle speed of each vehicle passing through the route, or may be acquired from the external server device 20. Accordingly, it is possible for the vehicle to be in a state where the communication in a 5G communication system is possible before the vehicle arrives at the first communication area 14. The switching deciding unit 36 may cause the communication controller 28 to start the switching process when the vehicle is at a position a predetermined distance before the first communication area 14. That is, the switching deciding unit 36 decides the switching start timing by time or distance.

The switching deciding unit 36 may decide the switching between the 4G communication system and the 5G communication system based on the guidance route information, the position information of the vehicle, and the area information. The switching deciding unit 36 determines whether the vehicle enters the first communication area 14 based on the guidance route information. When the vehicle enters the first communication area 14, the switching deciding unit 36 causes the communication controller 28 to start the switching process the predetermined time before the predicted arrival timepoint to the first communication area 14. It is possible to accurately determine that the vehicle enters the first communication area 14 using the guidance route information.

The switching deciding unit 36 decides the switching from the 5G communication system to the 4G communication system when the vehicle leaves the first communication area 14. The leaving of the vehicle from the first communication area 14 may be determined based on the position information of the vehicle and the area information or may be determined by disconnection from the installed antenna 12. As described above, the switching deciding unit 36 decides to switch to the communication in the 5G communication system before the vehicle enters the first communication area 14 and to switch to the communication in the 4G communication system after the vehicle leaves the first communication area 14. Accordingly, the communication in the 5G communication system is possible until the vehicle leaves the first communication area 14.

The switching deciding unit 36 restricts the switching to the 5G communication system when an information amount of the vehicle information scheduled to be transmitted to the server device 20 and to be stored in the storage unit 30 is equal to or less than a predetermined amount. For example, it takes a very long time to transmit the video stored in the drive recorder in the 4G communication, but a video for several hours can be transmitted in about several seconds in the 5G communication. The vehicle information to be stored in the storage unit 30 includes transmitted vehicle information and vehicle information scheduled to be transmitted. For example, when the vehicle information scheduled to be transmitted to the server device 20 has the information amount of 100 megabytes or less, the switching deciding unit 36 does not switch to the 5G communication system by maintaining the connection of the 4G communication system even when the vehicle approaches the first communication area 14. Accordingly, it is possible to avoid that the in-vehicle communication device 10 becomes unable to communicate during the switching process by not performing the switching process when the vehicle information scheduled to be transmitted does not accumulate.

When the communication controller 28 transmits or receives urgent information in a second communication system, the switching deciding unit 36 restricts the switching to the 5G communication system and maintains the connection of the 4G communication system even when the vehicle approaches the first communication area 14. The urgent information refers to information relating to the vehicle traveling to be communicated in an emergency, such as traffic accident information or failure information of a host vehicle. Accordingly, it is possible to avoid interruption of the communication of the urgent information due to the switching process of the communication system.

As described above, when the switching deciding unit 36 satisfies a switching restriction condition, the switching deciding unit 36 does not switch to the 5G communication system when the vehicle passes through the first communication area 14. The switching restriction condition is satisfied when the vehicle information scheduled to be transmitted is equal to or less than the predetermined amount or when the urgent information is communicated in the second communication system.

The communication controller 28 can communicate in any one of the 4G communication system and the 5G communication system. The communication controller 28 transmits the vehicle information stored in the storage unit 30 and scheduled to be transmitted to the server device 20. The storage unit 30 may discard the transmitted vehicle information in chronological order.

The communication controller 28 starts the switching process in response to the deciding of the switching deciding unit 36, for example, starts the switching process the predetermined time before the predicted arrival timepoint to the first communication area 14, and completes the switching process to the 5G communication system before the vehicle enters the first communication area 14. Accordingly, it is possible to use the communication in the 5G communication system as soon as the vehicle enters the first communication area 14.

The communication controller 28 starts the switching process from the 5G communication system to the second communication system when the vehicle leaves the first communication area 14. Accordingly, it is possible to use the 5G communication environment until the vehicle leaves the first communication area 14.

The communication controller 28 does not switch to the first communication system when the information amount of the vehicle information scheduled to be transmitted is equal to or less than the predetermined amount. When the communication controller 28 transmits or receives the urgent information, the communication controller 28 does not switch to the first communication system.

The switching deciding unit 36 may use congestion information acquired from the outside when the predicted arrival timepoint to the first communication area 14 is derived. The switching deciding unit 36 can accurately derive the predicted arrival timepoint by considering the congestion information.

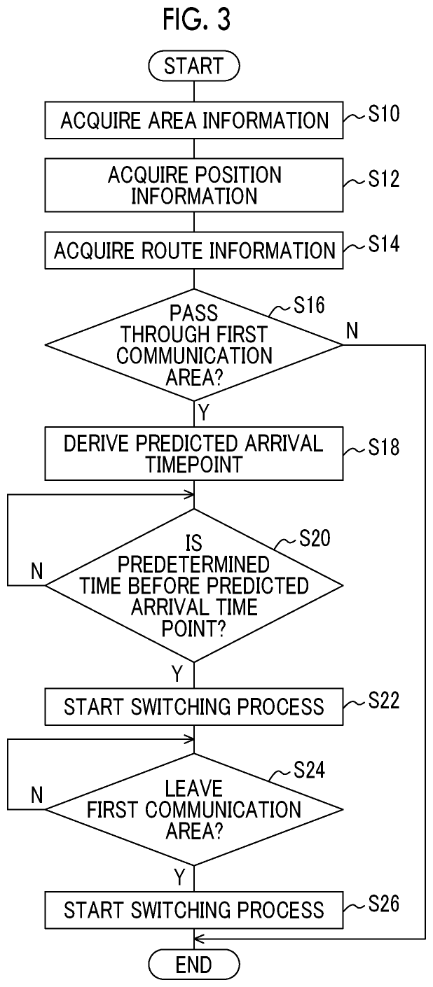

FIG. 3 is a flowchart of the switching process of the communication system. The area information holding unit 26 acquires the area information indicating the position and range of the first communication area 14 from the server device 20 (S10). The position acquisition unit 34 acquires the position information of the vehicle (S12). The route acquisition unit 32 acquires the guidance route information of the vehicle (S14).

The switching deciding unit 36 determines whether the vehicle is scheduled to pass through the first communication area 14 based on the guidance route information (S16). When the vehicle does not pass through the first communication area 14 (N in S16), this process ends. When the vehicle passes through the first communication area 14 (Y in S16), the switching deciding unit 36 derives the predicted arrival timepoint when the vehicle arrives at the first communication area 14 (S18).

The switching deciding unit 36 monitors until a current timepoint is the predetermined time before the predicted arrival timepoint (N in S20) and decides to start the switching process when the current timepoint is the predetermined time before the predicted arrival timepoint (Y in S20). The communication controller 28 starts the switching process in response to the deciding of the switching deciding unit 36 and completes the switching to the 5G communication system before the vehicle enters the first communication area 14 (S22).

The switching deciding unit 36 monitors whether the vehicle leaves the first communication area 14 based on the position information of the vehicle and the area information (N in S24) and decides the switching to the 4G communication system when the vehicle leaves the first communication area 14 (Y in S24). The communication controller 28 starts the switching process in response to the deciding of the switching deciding unit 36 and starts the switching to the 4G communication system after the vehicle leaves the first communication area 14 (S26).

The embodiment is merely an example, and those skilled in the art understand that various modifications are possible in combinations of the constituent components and such modification examples are within the scope of the disclosure.

In the embodiment, the aspect in which the switching of the communication system is decided on the in-vehicle communication device 10 side is shown. However, the disclosure is not limited to this aspect, and the switching process may be controlled on the server device 20 side. In this modification example, the server device 20 includes the configurations of the area information holding unit 26 and the switching deciding unit 36 that are included in the in-vehicle communication device 10. The server device 20 includes the area information holding unit configured to hold the area information indicating the position and range of the first communication area 14, and the switching deciding unit configured to decides the switching between the first communication system and the second communication system based on the vehicle position information acquired from the in-vehicle communication device 10 and the area information. The switching deciding unit of the server device 20 decides the switching from the second communication system to the first communication system before the vehicle enters the first communication area 14 and transmits an instruction signal for starting the switching process to the in-vehicle communication device. As described above, the communication method of switching the communication system can be configured of a system in which the in-vehicle communication device 10 and the server device 20 cooperate.

What is claimed is:

1. An in-vehicle communication device comprising:
a position acquisition unit configured to acquire vehicle position information; and
a communication controller configured to communicate in any one of a first communication system and a second communication system,
wherein the communication controller receives an instruction for switching derived based on a communication area where communication in the first communication system is possible and the vehicle position information and starts a switching process from the second communication system to the first communication system before a vehicle enters the communication area.

2. The in-vehicle communication device according to claim 1, wherein the communication controller completes the switching from the second communication system to the first communication system before the vehicle enters the communication area.

3. The in-vehicle communication device according to claim 1, wherein the communication controller starts a switching process from the first communication system to the second communication system when the vehicle leaves the communication area.

4. The in-vehicle communication device according to claim 1, further comprising:
a storage unit configured to store vehicle information to be transmitted to an external server device,
wherein the communication controller restricts the switching process to the first communication system when an information amount of the vehicle information scheduled to be transmitted to the server device and stored in the storage unit is equal to or less than a predetermined amount.

5. The in-vehicle communication device according to claim 1, wherein the communication controller restricts the switching process to the first communication system when the communication controller transmits or receives urgent information in the second communication system.

6. A communication method executed by an in-vehicle communication device communicable in any one of a first communication system and a second communication system, the method comprising:
a step of acquiring vehicle position information;
a step of holding area information indicating a communication area where communication in the first communication system is possible;
a step of deciding switching from the second communication system to the first communication system before a vehicle enters the communication area based on the vehicle position information and the area information; and
a step of starting a switching process from the second communication system to the first communication system before the vehicle enters the communication area in response to the deciding.

7. A server device that controls a switching process of a communication system in an in-vehicle communication device communicable in any one of a first communication system and a second communication system, the server device comprising:
an area information holding unit configured to hold area information indicating a communication area where communication in the first communication system is possible; and
a switching deciding unit configured to decides switching between the first communication system and the second communication system based on vehicle position information acquired from the in-vehicle communication device and the area information,
wherein the switching deciding unit decides the switching from the second communication system to the first communication system before a vehicle enters the communication area and transmits an instruction signal for starting the switching process to the in-vehicle communication device.
